(19) United States
(12) Patent Application Publication
(10) Pub. No.: US 2026/0140911 A1
(43) Pub. Date: May 21, 2026

(54) HETEROGENEOUS PROBABILISTIC COMPUTER ARCHITECTURE FOR SAMPLING AND OPTIMIZATION IN AI, COMPUTATIONAL SCIENCE AND OPERATIONAL RESEARCH

(71) Applicant: HEWLETT PACKARD ENTERPRISE DEVELOPMENT LP, Spring, TX (US)

(72) Inventors: Giacomo Pedretti, San Francisco, CA (US); Archit Gajjar, Timnath, CO (US); Masoud Mohseni, Calabasas, CA (US); Raymond Gerard Beausoleil, Seattle, WA (US)

(21) Appl. No.: 19/285,912

(22) Filed: Jul. 30, 2025

Related U.S. Application Data
(60) Provisional application No. 63/721,360, filed on Nov. 15, 2024.

(51) Int. Cl. G06F 13/42; G06F 13/40; G06F 17/16; G06N 10/40; G06N 10/60

(52) U.S. Cl. CPC G06F 13/4221; G06F 13/4063; G06F 17/16; G06N 10/40; G06N 10/60; G06F 2213/0026

(57) ABSTRACT

A heterogenous probabilistic computer architecture comprises a probabilistic processing unit (PPU), a central processing unit (CPU), a graphics processing unit (GPU), and a bus communicably connecting the PPU, CPU, and GPU. A heterogenous probabilistic computer using this architecture may form a sampling and optimization problem solver configured to process a sampling and optimization workload, such as an energy based model (EBM). In processing the sampling and optimization workload, the PPU may be used to generate samples, while the GPU may be used to compute gradients, weights, biases and/or other values related to the samples. The PPU and the GPU may communicate directly with one another using peer-to-peer communications via the bus. A quantum processing unit (QPU) may also be used, in some examples, to accelerate sampling.

### CROSS REFERENCE TO RELATED APPLICATION

This application claims priority to U.S. Provisional Application No. 63/721,360, filed Nov. 15, 2024, which is incorporated by reference herein in its entirety.

### INTRODUCTION

Sampling and optimization workloads in artificial intelligence (AI), operational research, and computational science are typically characterized by heavy, NP-hard computations. An example of a workload characterized by such operations are energy-based AI models.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operation. In the drawings:

FIG. 1 is a block diagram illustrating an example heterogeneous probabilistic computer.

FIG. 2 is a block diagram illustrating another example heterogeneous probabilistic computer.

FIG. 3 is a block diagram illustrating another example heterogeneous probabilistic computer.

FIG. 4 is a process flow diagram illustrating a method.

FIG. 5 is a block diagram illustrating an example non-transitory computer readable medium storing instructions.

### DETAILED DESCRIPTION

Energy-based models (EBM) are emerging as powerful, trustworthy, and explainable AI frameworks as a replacement for conventional transformer-based foundational models. However, training and inference of EBM in conventional accelerators can lead to high overhead due to heavy sampling operations. Probabilistic computers can perform sampling relatively efficiently. However, probabilistic computers are difficult to scale up for use in an EBM (or similar sampling or optimization workloads) because, although the generation of samples can be performed efficiently on the probabilistic processing unit (PPU) of the probabilistic computer, other computations (e.g., computations of loss and gradients) still need to be performed on a classical central processing unit (CPU), which creates a bottleneck.

To address these issues, disclosed herein are example heterogenous probabilistic computing architectures for sampling and optimization workloads (such as for EBM training and inference), in which a probabilistic processing unit (PPU) and a graphics processing unit (GPU) are combined, with the PPU generating the samples and the GPU performing the other computations, such as gradients and matrix multiples. Unlike a CPU, the GPU is optimized for performing these computations (e.g., gradients, matrix multiplications, or other linear algebra) and thus the aforementioned bottleneck due to CPU computation can be avoided. Thus, the heterogeneous architectures can allow for efficiently implementing and scaling up probabilistic computers, which may enable more efficient training of an EBM or execution of other sampling and/or optimization workloads.

In some examples, the heterogeneous architecture may further provide for peer-to-peer (P2P) communication between the PPU and the GPU, meaning that communications between the two do not need to pass through the CPU or main system memory. Usually, communications between peripheral components like a PPU and a GPU would go through the CPU and/or main system memory. But, in some applications, there is frequent back and forth between PPU and GPU and routing these communications through the CPU can create a substantial bottleneck. Using P2P communications between the PPU and the GPU can avoid this bottleneck and provide a significant increase in performance.

In some examples, the architecture may include multiple PPUs and multiple GPUs which all have P2P communications and a pool of virtually “shared” disaggregated memory, which further improves performance.

In some examples, the heterogeneous architecture may further provide a Quantum Processing Unit (QPU) to assist the PPU with sampling. The PPU may perform relatively easier sampling tasks, while the QPU performs relatively more complex sampling. Thus, high performance sampling can be seamlessly included to provide even further increases in performance.

Turning now to the figures, various devices, systems, and methods in accordance with aspects of the present disclosure will be described.

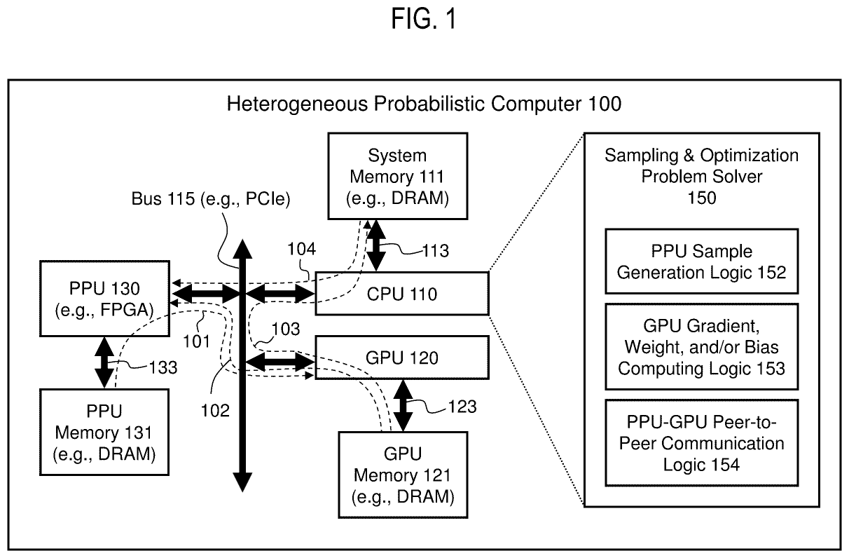

FIG. 1 is a block diagram conceptually illustrating a heterogeneous probabilistic computer 100 (“computer 100”). It should be understood that FIG. 1 is not intended to illustrate specific shapes, dimensions, positional relationships, or other structural details accurately or to scale, and that implementations of the heterogeneous probabilistic computer 100 may have different numbers and arrangements of the illustrated components and may also include other parts that are not illustrated.

The computer 100 comprises a CPU 100 and a system memory 111 connected to the CPU 111 by memory interface 113. In some examples, system memory 111 is dynamic random access memory (DRAM). In other examples, the system memory 111 may be another type of memory, such as high bandwidth memory (HBM). The memory interface 113 may be a double data rate (DDR) interface, which may include any generation of DDR (e.g., DDR, DDR-2, DDR-3, DDR-4, DDR-4, etc.), or any other type of memory interface appropriate for the type of memory being used.

The computer 100 also comprises a GPU 120 and a GPU memory 121 connected to the GPU 120 by memory interface 123. In some examples, the GPU 130 may be an integrated GPU that is part of the same system-on-chip (SoC) as the CPU 110. In some examples, the GPU 120 may be an expansion card that is communicably coupled to the CPU 110 via an expansion slot. In some examples, the GPU memory 121 may be DRAM. In some examples, the GPU memory 121 may be a form of DRAM specialized for GPUs, such as graphics DDR synchronous DRAM (GDDR SDRAM) or synchronous graphics RAM (SGRAM). In some examples, the GPU memory 121 may be another type of memory, such as HBM. The memory interface 123 may be a DDR interface, GDDR interface, HBM interface, or any other type of memory interface appropriate for the type of memory being used.

The computer 100 also comprises a PPU 130 and a PPU memory 131 connected to the PPU 130 by memory interface 133. The PPU 130 may be formed, in some examples, from a field programmable gate array (FPGA). In some examples, the PPU memory 131 may be DRAM. In some examples, the PPU memory 131 may be another type of memory, such as HBM. The memory interface 133 may be a DDR interface, HBM interface, or any other type of memory interface appropriate for the type of memory being used.

The computer 100 also comprises a communication bus 115 that is communicably connected to each of the CPU 110, GPU 120, and PPU 130. The bus 115 may include any type of computer communication bus that can allow for peer-to-peer communication between components. Peer-to-peer communication, in this context, refers to communication that can be exchanged directly between two components in the computer 100 without having to pass through the CPU 110. An example of a communication bus that can be used as the bus 115 is a peripheral component interconnect express (PCIe) bus.

The computer 100 also comprises a sampling and optimization problems solver 150 (“solver 150”). The solver 150 comprises PPU sample generation logic 152, GPU gradient, weight, and/or bias computing logic 153, and PPU-GPU peer-to-peer communication logic 154. The logic 152, 153, and 154 may comprise instructions stored in a non-transitory computer readable medium and executable by the CPU 110, GPU 120, and/or PPU 130 to cause operations described herein to be performed, dedicated hardware configured to perform operations described herein, or some combination of these. In examples where logic 152, 153, and 154 comprises instructions stored in a non-transitory computer readable medium, the sampling and optimization problems solver 150 may be instantiated by the CPU 110, GPU 120, and/or PPU 130 executing these instructions.

The solver 150 is configured to process or solve a sampling and/or optimization problem or workload. An example of a sampling problem or workload that the solver 150 may process is an energy based model (EBM). EBMs define probability distributions over data by associating an “energy” value with each possible state of the data. They aim to model the relationship between observed data and hidden representations by minimizing energy for observed patterns and maximizing it for unobserved patterns. For example, Boltzmann Machines (BM) are a type of EBM composed of visible (input) and hidden units arranged in a fully connected, symmetric network. BMs use an energy function that assigns low energy to configurations that correspond to likely patterns. BMs are trained using gradient-based methods, but convergence can be slow due to complex connections and dependencies between units. Restricted BMs are a simplified version of BMs with a bipartite structure (visible and hidden units are connected, but units within the same layer are not). The restricted BMs may be faster and easier to train than standard BMs using contrastive divergence, as the bipartite structure eliminates the need for inter-layer dependencies.

The solver 150 may be configured to process or solve the sampling and/or optimization problem or workload by using (e.g., executing instructions associated with) the logic 151, 152, and 153, as will be described in more detail below.

The PPU sample generation logic 152 causes the PPU 130 to generate samples. The manner in which the PPU 130 generates the samples may depend on the type of problem being solved, as would be familiar to those of ordinary skill in the art. For example, when the problem/workload is an EBM, the PPU 130 can generate samples according to a given distribution, such as the distribution

$${p}_{i} = \frac{1}{z} {e}^{- β {E}_{i}} .$$

PPUs, due to their probabilistic computing, are efficient at generating samples for sampling problems, and thus using the PPU 130 in this manner can accelerate the solving of the problem.

The GPU gradient, weight, and/or bias computing logic 153 causes the GPU 120 to compute gradients, weights, biases, and/or other linear algebra computations (e.g., matrix multiplication) based on the samples generated by the PPU. GPUs are optimized for performing computations like this, and therefore using the GPU 120 in this manner further accelerates the solving of the problem.

The PPU-GPU peer-to-peer communication logic 154 causes the PPU 130 and the GPU 120 to communicate with one another over the bus 115 via peer-to-peer communications. These peer-to-peer communications do not pass through or involve the CPU 110. For instance, one of the peer-to-peer communications may include the PPU 130 sending the samples it generates to the GPU 120, such that the GPU 120 can perform computations based on the samples. FIG. 1 illustrates a peer-to-peer communication path 101 from the PPU 130 to the GPU 120 which may be used for communicating the samples or other P2P communication. For instance, the samples may be stored in the PPU memory 131 and thus may be sent from PPU memory 131 to the GPU 120 via interface 133, PPU 130, and bus 115. Another example of a peer-to-peer communication between PPU and GPU may include the GPU 120 sending the gradients, weights, biases, and/or other values computed by the GPU 120 to the PPU 130, such that the PPU 130 can generate new samples based on these computed values. FIG. 1 illustrates a peer-to-peer communication path 102 from the GPU 120 to the PPU 130 which may be used for such a communication.

In contrast, a non peer-to-peer communication in a computing system between two peripheral components would pass through the CPU. But this adds additional interfaces and components through which the messages must pass, which increases the latency (delay) for each message. For instance, FIG. 1 illustrates a hypothetical communication from the GPU 120 to the PPU 130 which is not a peer-to-peer communication. This communication includes a first leg 103 in which data stored in the GPU memory 121 is communicated through the GPU 120 and bus 115 to the CPU 110 and stored in the system memory 111. Then, this data is conveyed via a second leg 104 from the system memory 111 through the CPU 110 and bus 115 to the PPU 130. As can be seen, this non peer-to-peer communication, represented by legs 103 and 104, must pass through many more interfaces and components than the communication 102. In addition to the latency added by passing through more interfaces, delays may also be added if the CPU is busy at the time of the communication. Many such messages are exchanged between the PPU 130 and the GPU 120 while they are processing a sampling and estimation problem, and therefore the increased latency for these messages can add up to significant cumulative delays and inefficiencies.

However, this bottleneck can be avoided by using the peer-to-peer communication between the PPU 130 and GPU 120. For instance, in some cases a peer-to-peer communication between GPU 120 and PPU 130 may have up to three times as much bandwidth as a similar non peer-to-peer communication.

The logic 152, 153, and 154 may be called upon repeatedly in multiple iterations until a solution is reached. For instance, initial samples may be generated by the PPU (logic 152) and fed to the GPU (logic 154), the GPU may compute gradients and other values based on the initial samples (logic 153) and then feed those computed values back to the PPU (logic 154), then the PPU may generate new samples based on the computed values (logic 152) and feed them to the GPU (logic 154), then the GPU may compute new gradients and other values based on the new samples (logic 153) and feed them back to the PPU (logic 154), and so on in repeated iterations until a solution is reached.

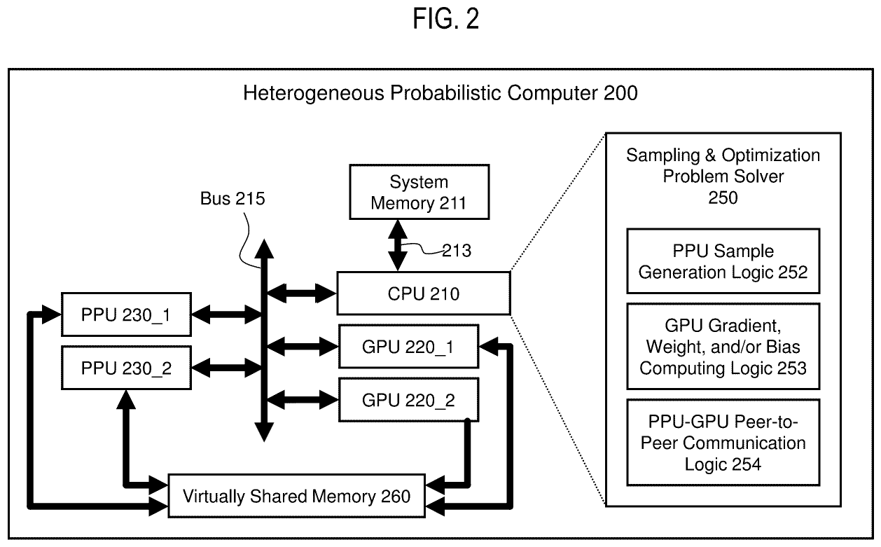

Turning now to FIG. 2, another heterogeneous probabilistic computer 200 (“computer 200”) will be described. FIG. 2 is a block diagram and is not intended to illustrate specific shapes, dimensions, positional relationships, or other structural details accurately or to scale, and that implementations of the heterogeneous probabilistic computer 200 may have different numbers and arrangements of the illustrated components and may also include other parts that are not illustrated.

The computer 200 includes a CPU 210 and system memory 211 connected to the CPU 210 by memory interface 213. CPU 210, system memory 211, and memory interface 213 may be similar to the CPU 110, system memory 111, and memory interface 113 described above.

The computer 200 also comprises multiple GPUs 220, with a GPU 220_1 and a GPU 220_2 being illustrated in FIG. 2 (more than two GPUs 220 may be present, in some examples). Each GPU 220 may be similar to the GPU 110 described above.

The computer 200 also comprises multiple PPUs 230, with a PPU 230_1 and a PPU 230_2 being illustrated in FIG. 2 (more than two PPUs 230 may be present, in some examples). Each PPU 230 may be similar to the PPU 110 described above.

The computer 200 also comprises a virtually shared memory 260 which is communicably connected to the PPUs 230 and the GPUs 220. The virtually shared memory 260 comprises one or more memory devices (e.g., DRAM) that are accessible to the PPUs and GPUs 220 and thus appear as if they were a single memory. The memory 260 is only “virtually” shared, however, as it in reality may comprise separate memory devices that may be specific to the GPUs 220 or PPUs 230. In particular, the virtual shared memory 260 may be composed of memory devices similar to the GPU memory 121 and PPU memory 131 from FIG. 1. These memory devices are described herein as being virtually shared because, in some examples, the peer-to-peer communication allows any of the PPUs 230 to access the data stored in the memory of any of the GPU 220 without going through the CPU 210 or the system memory 211, and thus the memories of the GPUs 220 can be effectively considered as being a single virtually “shared” memory (at least from the perspective of the PPUs 230). Similarly, in some examples, the GPUs 220 can access the PPU 230 memories through peer-to-peer, thus allowing it to effectively be considered virtual shared memory as well.

The computer 200 also comprises a communication bus 215 that is communicably connected to the CPU 210, each of the GPUs 220, and each of the PPUs 230. The bus 215 may be similar to bus 115.

The computer 200 also comprises a sampling and optimization problems solver 250 (“solver 250”). The solver 250 is configured to process or solve sampling and optimization problems or workloads, such as an EBM. The solver 250 comprises PPU sample generation logic 252, GPU gradient, weight, and/or bias computing logic 253, and PPU-GPU peer-to-peer communication logic 254. The logic 252, 253, and 254 may comprise instructions stored in a non-transitory computer readable medium and executable by the CPU 210, GPU 220, and/or PPU 230 to cause operations described herein to be performed, dedicated hardware configured to perform operations described herein, or some combination of these. In examples where logic 252, 253, and 254 may comprise instructions stored in a non-transitory computer readable medium, the sampling and optimization problems solver 250 may be instantiated by the CPU 210, GPU 220, and/or PPU 230 executing these instructions. The solver 250 may be configured to process or solve the sampling and optimization problems or workloads by calling upon or executing the logic 251, 252, and 253.

The PPU sample generation logic 252 causes each of the PPU 230 (e.g., PPUs 230_1 and 230_2) to generate samples.

The GPU gradient, weight, and/or bias computing logic 253 causes each of the GPUs 220 (e.g., GPUs 220_1 and 220_2) to compute gradients, weights, biases, and/or other linear algebra computations (e.g., matrix multiplication) based on the samples generated by the PPU.

The PPU-GPU peer-to-peer communication logic 254 causes the PPUs 230 and the GPUs 220 to communicate with one another over the bus 215 via peer-to-peer communications. In particular, in some examples, any one of the PPUs 230 can communicate with any other one of the PPUs 230 or with one of the GPUs 230 in a peer-to-peer manner, and similar any one of the GPUs 230 may communicate with any other one of the GPUs 230 or with any of the PPUs 230 in a peer-to-peer manner.

The addition of more PPUs 230 and more GPUs 220 to the computer 200, as compared to computer 100, provides even greater processing power, allowing larger sampling and optimization problems or workloads to be processed in an efficient manner. Moreover, the peer-to-peer communications and virtually shared memory 260 allows for scaling of the computer 200 to include many PPUs 230 and GPUs 220, while providing efficient communication and data sharing therebetween.

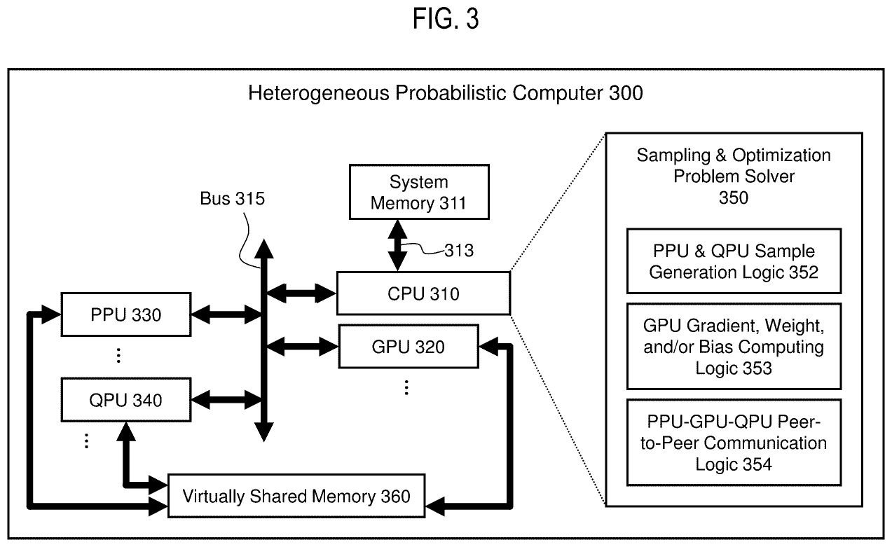

Turning now to FIG. 3, another heterogeneous probabilistic computer 300 (“computer 300”) will be described. FIG. 3 is a block diagram and is not intended to illustrate specific shapes, dimensions, positional relationships, or other structural details accurately or to scale, and that implementations of the heterogeneous probabilistic computer 300 may have different numbers and arrangements of the illustrated components and may also include other parts that are not illustrated.

The computer 300 includes a CPU 310 and system memory 311 connected to the CPU 310 by memory interface 313. CPU 310, system memory 311, and memory interface 313 may be similar to the CPU 110, system memory 111, and memory interface 113 described above.

The computer 300 also comprises one or more GPUs 320 (one is illustrated in FIG. 3, but more may be present in some examples). Each GPU 320 may be similar to the GPU 110 described above.

The computer 300 also comprises one or more PPUs 330 (one is illustrated in FIG. 3, but more may be present in some examples). Each PPU 330 may be similar to the PPU 110 described above.

The computer 300 also comprises one or more quantum processing units (QPUs) 340 (one is illustrated in FIG. 3, but more may be present in some examples). The QPUs 340 may comprise a collection of physically embodied qubits (a physical QPU) or it may be simulated using classical hardware (a simulated QPU). The QPUs 340 may be analog (e.g., based on quantum annealing) or digital (e.g., based on Quantum Approximation Optimization Algorithm (QAOA).

The computer 300 also comprises a virtually shared memory 360 which is communicably connected to the PPUs 330, the GPUs 320, and the QPUs 340. The virtually shared memory 360 comprises one more memory devices (e.g., DRAM) that are treated by computer 300 as if they were a single memory that can be accessed by any of the PPUs 330 and the GPUs 320.

The computer 300 also comprises a communication bus 315 that is communicably connected to the CPU 310, each of the GPUs 320, and each of the PPUs 330. The bus 315 may be similar to bus 115.

The computer 300 also comprises a sampling and optimization problems solver 350 (“solver 350”). The solver 350 is configured to process or solve a sampling and optimization problems or workload, such as an EBM. The solver 350 comprises PPU & QPU sample generation logic 352, GPU gradient, weight, and/or bias computing logic 353, and PPU-GPU-QPU peer-to-peer communication logic 354. The logic 352, 353, and 354 may comprise instructions stored in a non-transitory computer readable medium and executable by the CPU 310, GPU 320, and/or PPU 330 to cause operations described herein to be performed, dedicated hardware configured to perform operations described herein, or some combination of these. In examples where logic 352, 353, and 354 may comprise instructions stored in a non-transitory computer readable medium, the sampling and optimization problems solver 350 may be instantiated by the CPU 310, GPU 320, and/or PPU 330 executing these instructions. The solver 350 may be configured to process or solve the sampling and optimization problems or workloads by calling upon or executing the logic 351, 352, and 353.

The PPU and QPU sample generation logic 352 causes both the PPUs 330 and the QPUs 340 to generate samples. In some examples, the PPU(s) 330 may be caused to perform relatively easier sampling tasks, while the QPU(s) 340 may be caused to perform relatively more complex sampling. The QPUs 340 may be able to process some complex sampling operations faster than the PPU 330, and thus the addition of the QPUs 340 can provide even further increases in performance relative to the computer 200.

The GPU gradient, weight, and/or bias computing logic 353 causes each of the GPUs 320 to compute gradients, weights, biases, and/or other linear algebra computations (e.g., matrix multiplication) based on the samples generated by the PPUs 330 and QPUs 340.

The PPU-GPU-QPU peer-to-peer communication logic 354 causes the PPUs 330, the GPUs 320, and the QPUs 340 to communicate with one another over the bus 315 via peer-to-peer communications. For example, samples generated by the PPUs 330 and by the QPUs 340 may be communicated peer-to-peer to the GPUs 320, and computed values may be communicated peer-to-peer from the GPUs 320 to the PPUs 330 and the QPUs 340.

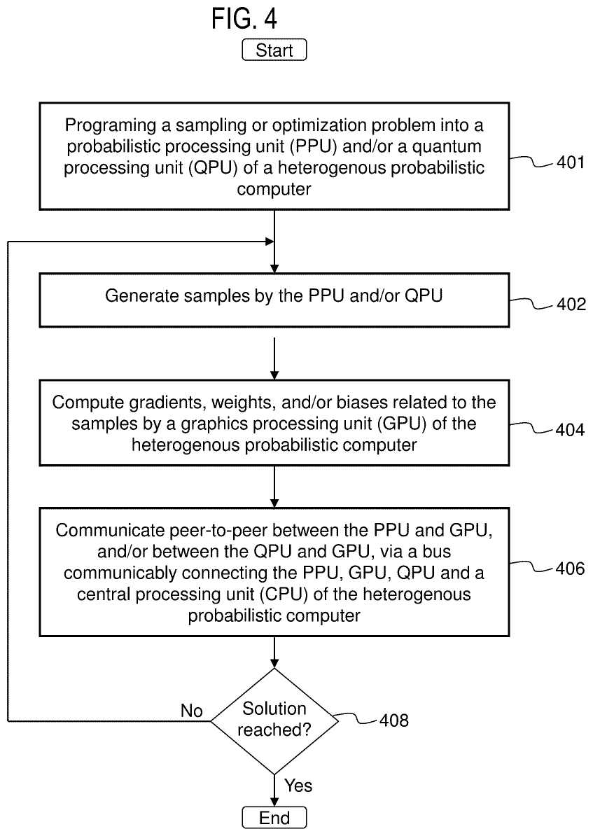

Turning to FIG. 4, an example method 400 will be described. The method 400 may be performed, for example, by a sampling and optimization problems solver of a heterogeneous probabilistic computer, or by a person utilizing the same. The method 400 comprises a loop which may be repeated in various interactions.

The method 400 begins at step 401. Step 401 comprises programming a sampling or optimization problem into a PPU and/or a QPU (if present) of a heterogeneous probabilistic computer. The method then proceeds to step 402.

Step 402 comprises generating samples by a probabilistic processing unit (PPU) of the heterogeneous probabilistic computer. In some examples, step 402 further comprises generating samples by multiple PPUs, such as by a first PPU and by a second PPU. In some examples, step 402 further comprises generating samples by a QPU. In some examples where a QPU is used, relatively more complex sampling is performed by the QPU and relatively more simple sampling is performed by the PPU(s). In some examples, the sampling is performed based on gradients, weights, biases, of other values computed by GPUs in a previous iteration of steps 402-408. The method then proceeds to step 404.

Step 404 comprises computing gradients, weights, biases, and/or linear algebra computations (e.g., matrix multiplication) related to the samples by a graphics processing unit (GPU) of the heterogenous probabilistic computer. In some examples, step 404 further comprises performing the computing with multiple GPUs, such as by a first GPU and by a second GPU. In some examples, the computations are performed based on the samples provided by the PPU(s) and/or QPUs (if present), as generated in step 402. The method then proceeds to step 406.

Step 406 comprises communicating peer-to-peer between the PPU and GPU via a bus communicably connecting the PPU, GPU, and a central processing unit (CPU) of the heterogenous probabilistic computer. The communicating peer-to-peer comprising communicating without involvement of the CPU. In some examples, the peer-to-peer communicating includes sending the samples generated by the PPU(s) and/or QPU(s) (if present) to the GPUs. In some examples, the peer-to-peer communicating includes sending the values computed by the GPUs to the PPU(s) and/or QPU(s) (if present). The method then proceeds to step 408.

Step 408 comprises determining whether a solution has been reached. If so (yes), the method 400 may end. If not (no), the method may loop back to step 402 for another iteration of the method.

Note that step 404 is described before step 406 above out of convenience, but in practice some or all of step 406 could be performed before step 404. For instance, the peer-to-peer communicating of step 406 could include the PPUs sending their samples to the GPUs, and this may occur before the GPUs perform the computations of step 404.

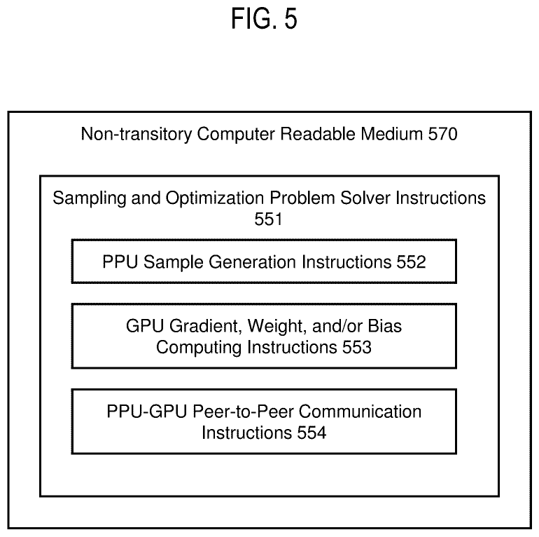

Turning to FIG. 5, an example non-transitory computer readable medium 570 will be described. The medium 570 may be any data storage device (or multiple such devices) that is non-transitory, such as a hard drive, solid state drive, flash media, optical disk, magnetic storage media, etc. The medium 570 stores sampling and optimization problem solver instructions 551, which are executable by a processor (e.g., of a CPU, PPU, or GPU) to instantiate a sampling and optimization problem solver, such as any of the solvers 150, 250, or 350 described above.

The instructions 551 include PPU sample generation instructions 552. These instructions 552 are executable by a processor to cause the operations described above in relation to logic 152, 252, or 352 to be performed. In other words, instructions 552 are one example implementation of logic 152, 252, or 352.

The instructions 551 include GPU gradient, weight, and/or bias computing instructions 553. These instructions 553 are executable by a processor to cause the operations described above in relation to logic 153, 253, or 353 to be performed. In other words, instructions 553 are one example implementation of logic 153, 253, or 353.

The instructions 551 include PPU-GPU peer-to-peer communication instructions 554. These instructions 554 are executable by a processor to cause the operations described above in relation to logic 154, 254, or 354 to be performed. In other words, instructions 554 are one example implementation of logic 154, 254, or 354.

It is to be understood that both the general description and the detailed description provide examples that are explanatory in nature and are intended to provide an understanding of the present disclosure without limiting the scope of the present disclosure. Various mechanical, compositional, structural, electronic, and operational changes may be made without departing from the scope of this description and the claims. In some instances, well-known circuits, structures, and techniques have not been shown or described in detail in order not to obscure the examples. Like numbers in two or more figures represent the same or similar elements.

In addition, the singular forms “a”, “an”, and “the” are intended to include the plural forms as well, unless the context indicates otherwise. Moreover, the terms “comprises”, “comprising”, “includes”, and the like specify the presence of stated features, steps, operations, elements, and/or components but do not preclude the presence or addition of one or more other features, steps, operations, elements, components, and/or groups. Components described as connected may be electronically or mechanically directly connected, or they may be indirectly connected via one or more intermediate components, unless specifically noted otherwise. Mathematical and geometric terms are not necessarily intended to be used in accordance with their strict definitions unless the context of the description indicates otherwise, because a person having ordinary skill in the art would understand that, for example, a substantially similar element that regions in a substantially similar way could easily fall within the scope of a descriptive term even though the term also has a strict definition.

And/or: Occasionally the phrase “and/or” is used herein in conjunction with a list of items. This phrase means that any combination of items in the list—from a single item to all of the items and any permutation in between—may be included. Thus, for example, “A, B, and/or C” means “one of {A}, {B}, {C}, {A, B}, {A, C}, {C, B}, and {A, C, B}”.

Elements and their associated aspects that are described in detail with reference to one example may, whenever practical, be included in other examples in which they are not specifically shown or described. For example, if an element is described in detail with reference to one example and is not described with reference to a second example, the element may nevertheless be claimed as included in the second example.

Unless otherwise noted herein or implied by the context, when terms of approximation such as “substantially,” “approximately,” “about,” “around,” “roughly,” and the like, are used, this should be understood as meaning that mathematical exactitude is not required and that instead a range of variation is being referred to that includes but is not strictly limited to the stated value, property, or relationship. In particular, in addition to any ranges explicitly stated herein (if any), the range of variation implied by the usage of such a term of approximation includes at least any inconsequential variations and also those variations that are typical in the relevant art for the type of item in question due to manufacturing or other tolerances. In any case, the range of variation may include at least values that are within ±1% of the stated value, property, or relationship unless indicated otherwise.

Further modifications and alternative examples will be apparent to those of ordinary skill in the art in view of the disclosure herein. For example, the devices and methods may include additional components or steps that were omitted from the diagrams and description for clarity of operation. Accordingly, this description is to be construed as illustrative only and is for the purpose of teaching those skilled in the art the general manner of carrying out the present teachings. It is to be understood that the various examples shown and described herein are to be taken as exemplary. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the scope of the present teachings and following claims.

It is to be understood that the particular examples set forth herein are non-limiting, and modifications to structure, dimensions, materials, and methodologies may be made without departing from the scope of the present teachings.

Other examples in accordance with the present disclosure will be apparent to those skilled in the art from consideration of the specification and practice of the invention disclosed herein. It is intended that the specification and examples be considered as exemplary only, with the following claims being entitled to their fullest breadth, including equivalents, under the applicable law.

What is claimed is:

1. A heterogeneous probabilistic computer, comprising:
a probabilistic processing unit (PPU);
a central processing unit (CPU);
a graphics processing unit (GPU);
a bus communicably connecting the PPU, CPU, and GPU;
one or more non-transitory computer readable media storing instructions executable by the CPU, PPU, and/or GPU to instantiate a sampling and optimization problem solver configured to process a sampling and optimization workload by:
generating samples by the PPU;
computing gradients, weights, and/or biases related to the samples by the GPU; and
communicating peer-to-peer between the PPU and GPU via the bus.

2. The heterogeneous probabilistic computer of claim 1, wherein computing the gradients, weights, and/or biases comprises performing matrix multiplication or other linear algebra by the GPU.

3. The heterogeneous probabilistic computer of claim 1, wherein the communicating peer-to-peer between the PPU and GPU via the bus comprises exchanging a communication between the PPU and the GPU without the communication involving the CPU.

4. The heterogeneous probabilistic computer of claim 1, further comprising system memory communicably connected to the CPU and GPU memory communicably connected to the GPU, wherein the communicating peer-to-peer between the PPU and GPU comprises retrieving data from the GPU memory for the PPU without accessing the system memory.

5. The heterogeneous probabilistic computer of claim 1, further comprising a second PPU connected to the bus and a second GPU connected to the bus.

6. The heterogeneous probabilistic computer of claim 5, wherein the PPU, the second PPU, the GPU, and the second GPU can each communicate peer-to-peer with one another via the bus.

7. The heterogeneous probabilistic computer of claim 5, further comprising a pool of virtually shared memory accessible to the PPU, the second PPU, the GPU, and the second GPU.

8. The heterogeneous probabilistic computer of claim 5, further comprising one or more quantum processing units (QPU), wherein the sampling and optimization problem solver is further configured to process the sampling and optimization workload by generating samples by the one or more QPUs.

9. The heterogeneous probabilistic computer of claim 8, wherein the sampling and optimization problem solver is further configured to process the sampling and optimization workload by generating more complex samples by the one or more QPUs and simpler samples by the PPU or second PPU.

10. The heterogeneous probabilistic computer of claim 8, wherein the PPU, the second PPU, the GPU, the second GPU, and the one or more QPUs can each communicate peer-to-peer with one another via the bus.

11. The heterogeneous probabilistic computer of claim 1, further comprising a quantum processing unit (QPU), wherein the sampling and optimization problem solver is further configured to process the sampling and optimization workload by generating samples by the QPU.

12. The heterogeneous probabilistic computer of claim 11, wherein the sampling and optimization problem solver is further configured to process the sampling and optimization workload by generating more complex samples by the QPU and simpler samples by the PPU.

13. The heterogeneous probabilistic computer of claim 1, wherein the sampling and optimization workload comprises an energy-based model.

14. The heterogeneous probabilistic computer of claim 1, wherein the PPU is embodied by a field programmable gate array (FPGA).

15. The heterogeneous probabilistic computer of claim 1, wherein the bus is a peripheral component interconnect express (PCIe) bus.

16. A method for processing a sampling and optimization workload by a heterogeneous probabilistic computer, comprising:
generating samples by a probabilistic processing unit (PPU) of the heterogeneous probabilistic computer;
computing gradients, weights, and/or biases related to the samples by a graphics processing unit (GPU) of the heterogeneous probabilistic computer; and
communicating peer-to-peer between the PPU and GPU via a bus communicably connecting the PPU, GPU, and a central processing unit (CPU) of the heterogeneous probabilistic computer, the communicating peer-to-peer comprising communicating without involvement of the CPU.

17. The method of claim 16, further comprising:
generating samples by a second PPU of the heterogeneous probabilistic computer;
computing gradients, weights, and/or biases by a second GPU; and
communicating peer-to-peer between the PPU, the second PPU, the GPU, and the second GPU via the bus.

18. The method of claim 16, further comprising:
generating samples by a quantum processing unit (QPU); and
communicating peer-to-peer between the PPU, GPU, and QPU via the bus.

19. The method of claim 18, further comprising generating more complex samples by the QPU and simpler samples by the PPU.

20. A non-transitory computer readable medium storing instructions executable by one or more processors of a heterogeneous probabilistic computer to instantiate a sampling and optimization problem solver configured to process a sampling and optimization workload by:
generating samples by a probabilistic processing unit (PPU) of the heterogenous probabilistic computer;
computing gradients, weights, and/or biases related to the samples by a graphics processing unit (GPU) of the heterogenous probabilistic computer; and
communicating peer-to-peer between the PPU and GPU via a bus communicably connecting the PPU, GPU, and a central processing unit (CPU) of the heterogenous probabilistic computer, the communicating peer-to-peer comprising communicating without involvement of the CPU.
